(19) United States
(12) Patent Application Publication
(10) Pub. No.: US 2008/0105845 A1
(43) Pub. Date: May 8, 2008

(54) BALL VALVE WITH FLOW-THROUGH FEATURE

(75) Inventor: Arthur R. Yeary, Chicago, IL (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: YEARY & ASSOCIATES, INC., Chicago, IL (US)

(21) Appl. No.: 11/934,987

(22) Filed: Nov. 5, 2007

Related U.S. Application Data
(60) Provisional application No. 60/857,240, filed on Nov. 7, 2006.

(51) Int. Cl. F16K 5/06

(52) U.S. Cl. 251/315.16; 251/315.01

(57) ABSTRACT

A ball valve design with two sets of curved, smooth surfaces on the quarter-turn ball member to provide tight sealing in the fully closed position and protect the seat rings in the fully open position, with wiping action during opening and closing, thus avoiding particulate buildup. Compared to traditional ball valves, substantial, non-essential surface areas of the ball member are eliminated, which minimizes contact with the seat rings, thus reducing wear as well as operating torques as a direct result of reduced friction. The eliminated volume around the ball member creates an envelope for carrying particulate to be freely discharged into the downstream side when the valve is cycled from the closed to the open position. The cavity created around the raised spherical surfaces on the quarter-turn ball member also provides an envelope for modulating flow for control applications.

### CROSS-REFERENCE TO RELATED APPLICATION

The present application is based on and claims priority to U.S. Provisional Patent Application Ser. No. 60/857,240, filed on Nov. 7, 2006.

### BACKGROUND OF THE INVENTION

Quarter-turn ball valves have been preferred for many years in various types of valving applications for the simplistic operation, high flow capacity, compactness, relatively light-weight, reliable stem seals and the ease of automation. Quarter-turn ball valves have a big advantage over multi-turn valves, especially when automation is required, since their one-fourth turn (900) operation, compactness, light-weight and low operating torque provides for ease of installation and economy of actuation. As compared to multi-turn valves, such as gate and globe valves, a one-quarter turn ball valve is simpler to operate and maintain and, unlike linear stroking valves, has the advantage of turning within its own axis. Quarter-turn ball valves have been used in many different industries, such as oil and gas, power generation, pulp and paper, chemical, cryogenics, food and beverage, water and waste water, aircraft and aerospace, marine, mining and metals and pipeline applications.

Although quarter-turn ball valves have proven effective in many of these applications, ordinary quarter-turn ball valves allow fluid media and debris to be trapped between the ball and the inner-body cavity, which can result in the accumulation of debris around the ball, which over time can result in damage to the valve seating surfaces. Therefore, it is an object of the present invention to provide an improved ball valve that allows debris to be flushed from the inner-body cavity to prevent the accumulation of solid matter around the backside of the seating rings and bearings.

### SUMMARY OF THE INVENTION

In view of the foregoing factors and condition characteristics of the prior art, it is a primary object of the present invention to provide a new and improved ball valve device.

Another object of the present invention is to provide a simple, yet effective, ball valve that avoids a tendency to load particles and create buildup on the valve seats and the outer surface of the ball, minimizes contact and friction with the seat rings, reduces wear and operating torques, and thus extends the valve life and provides economic advantage in selection of actuator.

Still another object of the present invention is to provide a highly configurable spherical surface, including one with built-in cam action, along the path of the quarter-turn moving member coming in contact with the valve seats, allowing flexibility in design of the valve seat/sealing mechanism.

A further object of the present invention is to provide a relatively low cost manufacturing for the ball member. The ball member includes a spherical outer surface that can be machined to include a pair of flat side surfaces and a recessed, relieved area to reduce the amount of material required to form the ball member while providing the required sealing lips to seal the valve in both the open and closed positions.

In accordance with an embodiment of the present invention, an improved quarter-turn ball member is provided having two sets of raised spherical surfaces that are in full contact with the valve seats only in the full open or full closed positions. In the full closed position, two opposed, raised spherical surfaces are fully engaged with the valve seats, thus providing tight sealing. In the full open position, the other two opposed, raised spherical surfaces, perpendicular to the open port, fully cover and protect the valve seats. During opening or closing cycles, the two opposed raised spherical surfaces provide a wiping, or scraping action, to clean the valve seats, thus avoiding buildup and allowing debris to be carried around the ball member within the created volume, and discharged freely out from the downstream side of the valve. The eliminated surface area minimizes contact and friction with the seat rings, thus reducing wear as well as operating torques.

The present invention, both as to its organization and manner of operation, together with further objects and advantages thereof, may be best understood by making reference to the following description taken in conjunction with the accompanying drawings in which like reference characters refer to like elements in several views.

### BRIEF DESCRIPTION OF THE DRAWINGS

The drawings illustrate the best mode presently contemplated of carrying out the invention. In the drawings:

FIG. 1 is a top, section view of a prior art ball valve shown in a partially open position;

FIG. 2 is a perspective view of a prior art ball valve that includes a generally spherical outer surface and a pair of opposed openings to a flow passageway;

FIG. 3 is a perspective view of the ball member of the present invention illustrating the pair of oppositely located inlets to a flow passageway through the ball valve and a pair of planar side surfaces;

FIG. 4 is a section view taken through the ball member of FIG. 3;

FIG. 5 is a top, section view of the ball valve of the present invention illustrating the flow of fluid along the outer surface of the ball member to flush debris and solids; and

FIG. 6 is a side, section view illustrating the flow of fluid through a ball valve assembly including the ball valve of the present invention.

### DETAILED DESCRIPTION OF THE INVENTION

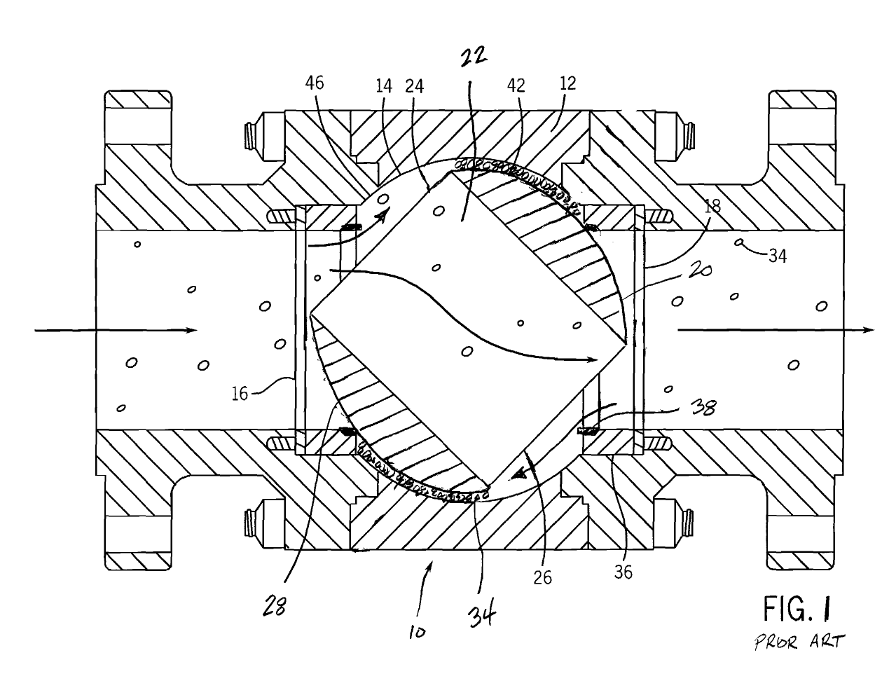

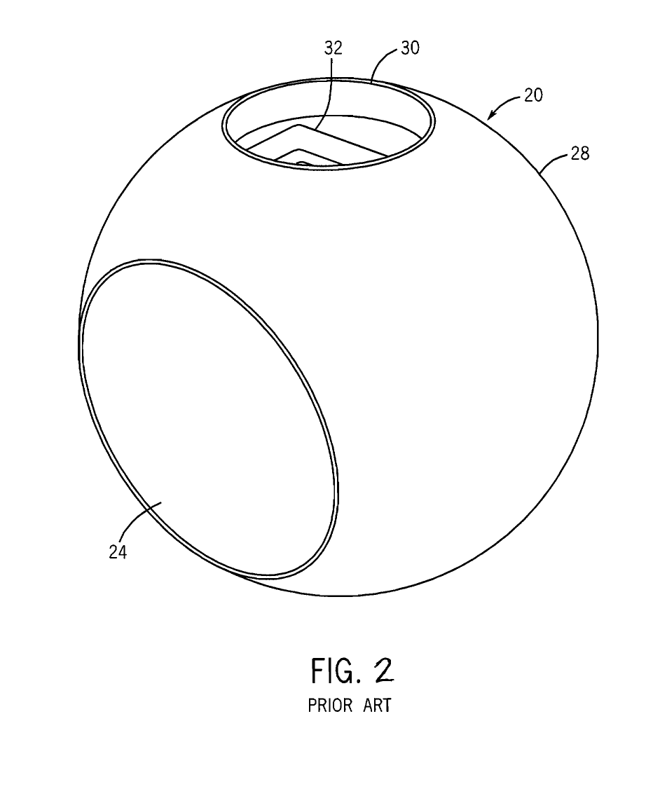

Referring first to FIG. 1, thereshown is a valve assembly 10 that represents a prior art, quarter-turn ball valve that has been available for many years. The valve assembly 10 includes a valve body 12 that defines an inner-body cavity 14 that extends between an inlet 16 and an outlet 18 to selectively allow fluid to flow through the valve assembly 10. As illustrated in FIG. 1, the inner cavity 14 contains a ball member 20 that can rotate a quarter-turn (900) within the inner cavity 14. The ball member 20 includes a flow passageway 22 that extends between an inlet 24 and an outlet 26 of the ball member 20. The ball member 20 includes a generally spherical outer surface 28, as can be seen in FIGS. 1 and 2. As illustrated in FIG. 2, the top of the spherical ball member 20 includes a recessed area 30 including a valve stem receiving area 32. The receiving area 32 receives the valve stem of the valve assembly and allows the ball member 20 to be rotated 90° within the inner cavity of the valve assembly.

Referring back to FIG. 1, when the ball member 20 is in the partially open position as shown, debris 34 has a tendency to accumulate in the low pressure areas within the inner cavity 14, as shown. In applications in which the ball valve is used with fluid including entrained particles, such as sand or other abrasive elements, the accumulation of debris 34 along the outer surface 28 of the ball member can have a detrimental effect on the durability of the valve assembly 10.

Specifically, when the ball member 20 includes an accumulation of debris 34 and rotates from the position shown in FIG. 1 to a fully closed position, the debris 34 contained on the outer surface 28 contacts the seating assembly 36 positioned at both the inlet and the outlet of the valve body 12. Typically, the seating assembly 36 includes a resilient seat 38 that forms a fluid-tight seal around the outer surface of the ball member. However, if the outer surface of the ball member includes the accumulation of debris, the debris, over a number of cycles, wears down the seat 38, thereby decreasing the performance of the ball valve assembly and necessitating maintenance.

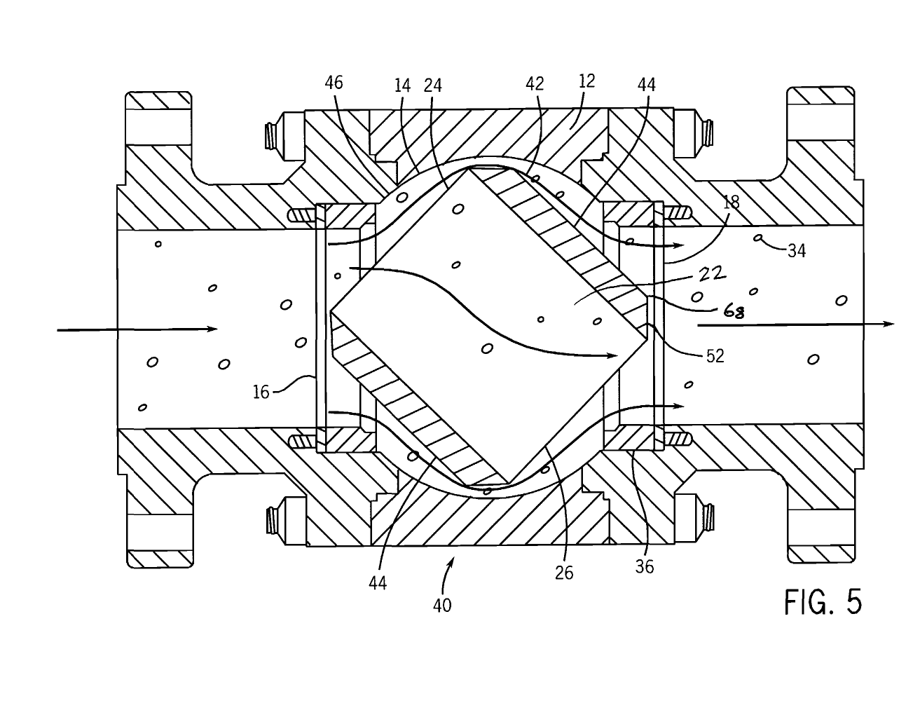

Referring now to FIG. 5, thereshown is a valve assembly 40 constructed in accordance with the present invention. In the valve assembly 40 shown in FIG. 5, the valve assembly includes an improved ball member 42. Like the ball member 20 shown in FIG. 1, the ball member 42 includes an inlet 24 and an outlet 26 that define a flow passageway 22 through the ball member 42. However, unlike the ball valve shown in FIG. 1, the ball member 42 includes a pair of generally flat side surfaces 44 formed in the otherwise generally spherical outer surface of the ball member 42. As illustrated in FIG. 5, when the ball member 42 is in the partially open position, fluid can flow between the outer surface of the ball member 42 and the inner surface 46 that defines the inner cavity 14. Thus, when the ball member 42 is in the partially open position, a small amount of fluid flows along the outer surface of the ball member 42 to prevent the accumulation of debris 34.

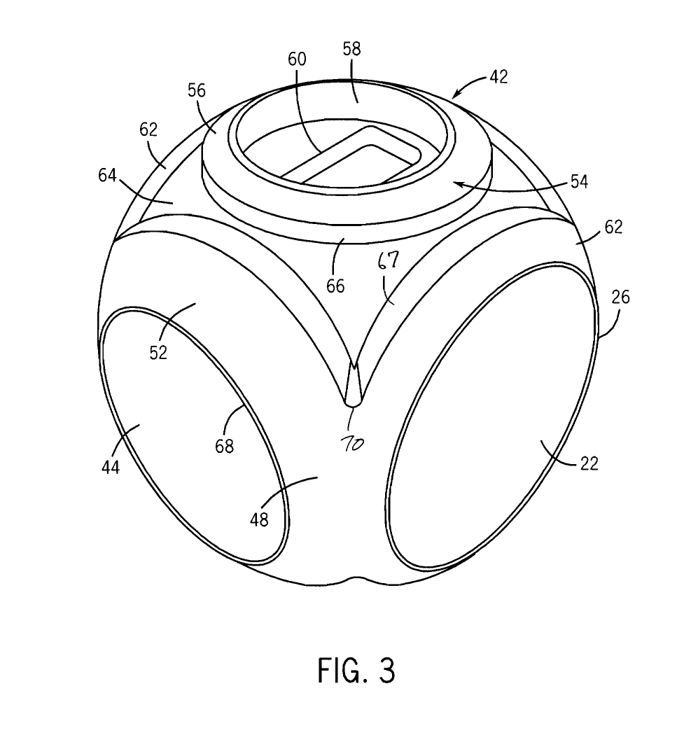

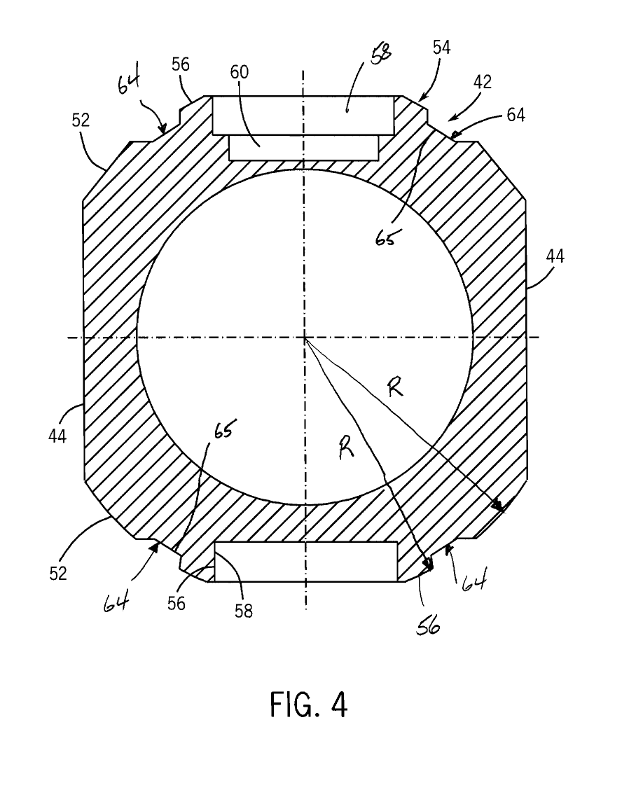

Referring now to FIG. 3-4, thereshown are detailed views of the ball member 42 constructed in accordance with the present invention. The ball valve 42 includes a generally spherical outer surface 48 and a flow passageway 22 that extends through the center of the ball member. As illustrated in FIG. 4, the ball member 42 includes a pair of opposed, flat side surfaces 44 that are each defined by a curved, side sealing lip 52. As can be seen in FIG. 4, the curved, side sealing lip 52 is formed having a radius of curvature R that is the same as the radius of curvature of the outer surface of the generally spherical ball valve 42. Each of the side surfaces 44 is a planar surface machined from the otherwise spherical outer surface of the ball member.

In addition to the side surfaces 44, the ball member includes a trunnion 54 defined by a sloping outer rim 56, which in turn defines the recessed area 58 that includes the valve stem receiving area 60. As can be understood by a comparison of FIGS. 2 and 4, the recessed areas 30, 58 and receiving areas 32, 60 generally correspond to each other such that the ball member 20 shown in FIG. 2 can be replaced by the ball member 42 shown in FIG. 4.

As shown in FIG. 3, the trunnion 54 is set off from the side sealing lip 52 surrounding the side surfaces 44 and the lip 62 surrounding the outlet 26 and the inlet (not shown) by a relieved area 64. The relieved area 64 is machined from the generally spherical outer surface 48 of the ball member 42 and defines a set off wall 66 that forms the outer rim 56 and the set off wall 67 that forms both the sealing lip 52 and the sealing lip 62. The relieved areas 64 are each defined by an inner wall 65 that is recessed radially inward from the side sealing lip 52 and the outer rim 56. The relieved areas 64 provide another flow path for debris to pass along the outer surface of the ball member 42 when the ball valve is in a partially open position, such as shown in FIG. 5.

Referring now to FIG. 4, the radius of the side sealing lip 52 surrounding the side surface 44 matches the radius of the sloped outer rim 56 that defines the trunnion 54. During manufacture of the ball member 42, the outer surface of the ball member 42 is formed with a smooth, spherical configuration and a portion of the ball member 42 is machined away to define the generally planar side surfaces 44 and the relieved areas 64.

In addition to the sealing lip 52 and the outer rim 56, the sealing lips 62 surrounding both the inlet and the outlet 26 to the flow passageway have the same radius of curvature as the outer surface 48. As shown in FIG. 3, the sealing lip 52 and the sealing lip 62 merge together at a junction point 70. Since the relieved areas 64 are machined from the otherwise spherical outer surface 48 of the ball member, the relieved areas 64 define the top and bottom edges of both the sealing lip 52 and the sealing lip 62.

In the preferred embodiment of the invention, the ball member is formed from a hard chromed stainless steel.

As can be understood in FIG. 5, when the ball member 42 is in its fully closed position, the side sealing lip 52 contacts the seating assembly 36 to provide a fluid-tight seal around the ball member. As the ball member 42 rotates to an open position, an edge surface 68 (FIG. 5) that defines the junction between the planar side surface 44 and the side sealing lip 52 contacts the seating assembly 36 to clean the seating assembly of any debris. Thus, in accordance with the present invention, the improved quarter-turn ball valve includes two sets of parallel side surfaces 44 that are in contact with the valve seats in the fully closed position. In the fully closed position, the two parallel side surfaces 44 are fully engaged with the valve seats, thus providing tight sealing. In the full open position, the side sealing lips 52 fully cover and protect the valve seats. In this manner, the two sets of sealing lips 52 provide a wiping, or scraping action during opening and closing of the ball valve which cleans the valve seats and avoids buildup. Further, as was shown in FIG. 5, the configuration of the ball member 42 allows debris to be carried around the ball member within the inner cavity 14, thus allowing debris to be discharged freely from the downstream side of the valve.

In addition to providing the features described above, the pair of planar side surfaces 44 reduce the surface area of the ball member to minimize contact and friction with the seat rings, thus reducing wear as well as reducing operating torque. Both these features extend the valve life and provide economic advantages in the selection of the valve actuator. The two sets of parallel sealing lips 52 provide flexibility in the design for configuring an optimizing cam action loading against the seating rings, thus facilitating innovation of more effective sealing mechanisms.

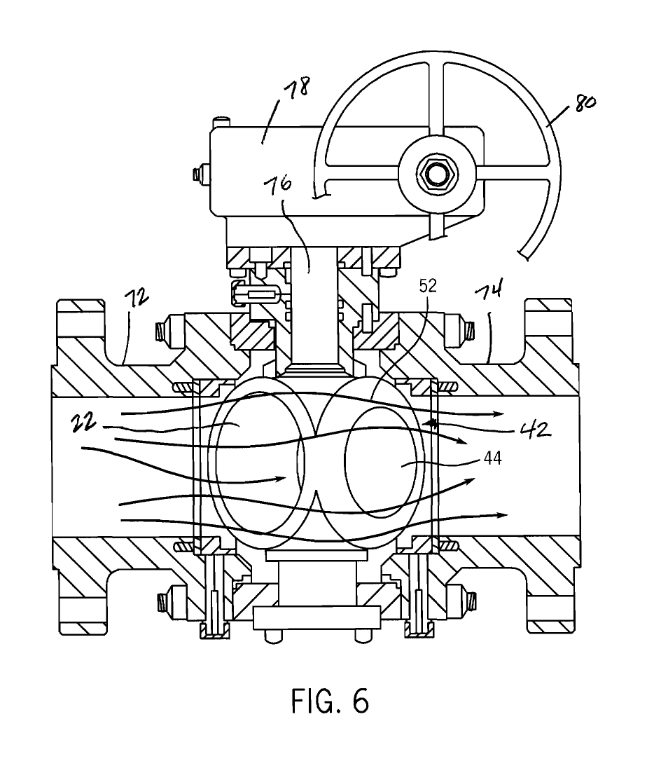

FIG. 6 illustrates the positioning of the ball member 42 within a piping arrangement between an inlet pipe 72 and an outlet pipe 74. The ball member 42 receives the valve stem 76 from a valve actuator 78 including a handle 80 that is operable to rotate the ball member 42 between its fully open and fully closed positions. When the ball member 42 is in the partially open position shown in FIG. 6, fluid and debris is able to pass over the flat side surfaces 44 to prevent the accumulation of debris. Likewise, when the ball member 42 is in the fully closed position, fluid and debris can pass through the flow passageway 22 in a conventional manner.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

I claim:

1. A valve assembly for use in regulating the flow of a fluid through the valve assembly, comprising:
a valve body including an inlet and an outlet and defining a valve chamber therebetween;
a ball member rotatably mounted within the valve chamber and movable between an open position and a closed position, the ball member comprising:
a spherical outer surface;
a flow passageway extending through the ball member from a ball inlet to a ball outlet;
an upper trunnion formed on a top end of the spherical outer surface, the upper trunnion including a trunnion outer rim;
a pair of parallel, flat side surfaces formed in the spherical outer surface of the ball member, each of the side surfaces being surrounded by a side sealing lip; and
at least an upper and a lower relieved area, the upper and lower relieved areas being recessed from the spherical outer surface to define the side sealing lips and the trunnion outer rim,
wherein the spherical outer surface, the side sealing lips and trunnion outer rim have the same radius of curvature; and
a valve actuator received in the upper trunnion and operable to move the ball member between the open and closed positions.

2. The valve assembly of claim 1 wherein the relieved areas are formed by removing portions of the spherical outer surface.

3. The valve assembly of claim 1 wherein the upper and lower relieved areas each include an inner wall surface spaced radially inward from the trunnion outer rim and the side sealing lips.

4. The valve assembly of claim 1 wherein the ball member further comprises a pair of second sealing lips each surrounding one of the ball inlet and the ball outlet, the second sealing lip having the same radius of curvature as the spherical outer surface.

5. The valve assembly of claim 4 wherein the second sealing lips contact a seal member of the valve body when the ball member is in the open position and the side sealing lips contact the seal member when the ball member is in the closed position.

6. A ball member for use within a valve assembly, the ball member being rotatable between an open position and a closed position within the valve assembly, the ball member comprising:
a spherical outer surface;
a flow passageway extending through the ball member from a ball inlet to a ball outlet;
an upper trunnion formed on a top end of the spherical outer surface and including a recessed actuator receptacle and a trunnion outer rim;
a pair of parallel, flat side surfaces formed in the spherical outer surface, each of the side surfaces being surrounded by a side sealing lip; and
at least an upper and a lower relieved area, both the upper and lower relieved areas being recessed from the spherical outer surface to define the side sealing lips and the trunnion outer rim;
wherein the spherical outer surface, the side sealing lips and the trunnion outer rim have the same radius of curvature.

7. The ball member of claim 6 wherein the relieved areas are formed by removing portions of the spherical outer surface.

8. The ball member of claim 6 wherein the upper and lower relieved areas each include an inner wall surface spaced radially inward from the trunnion outer rim and the side sealing lips.

9. The ball member of claim 1 wherein the ball member further comprises a pair of second sealing lips each surrounding one of the ball inlet and the ball outlet, the second sealing lips having the same radius of curvature as the spherical outer surface.

10. The ball valve of claim 9 wherein the second sealing lips contact a seal member of the valve assembly when the ball member is in the open position and the side sealing lips contact the seal members when the ball member is in the closed position.

11. A ball member for use within a valve assembly, the ball member being rotatable between an open position and a closed position within the valve assembly, the ball member comprising:
a spherical outer surface;
a flow passageway extending through the ball member from a ball inlet to a ball outlet;
an upper trunnion formed on a top end of the spherical outer surface and including a recessed actuator receptacle and a trunnion outer rim;
at least an upper and a lower relieved area, both the upper and lower relieved areas being recessed from the spherical outer surface to define the trunnion outer rim;
wherein the spherical outer surface and the trunnion outer rim have the same radius of curvature.

12. The ball member of claim 11 wherein the relieved areas are formed by removing portions of the spherical outer surface.

13. The ball member of claim 11 wherein the upper and lower relieved areas each include an inner wall surface spaced radially inward from the trunnion outer rim.

14. The ball member of claim 12 wherein the upper and lower relieved areas define a pair of side sealing lips, wherein the side sealing lips are operable to contact a seal member of the valve assembly when the ball member is in the closed position.

15. The ball member of claim 14 wherein the upper and lower relieved areas further define a pair of second sealing lips each surrounding one of the ball inlet and the ball outlet, the second sealing lips having the same radius of curvature as the spherical outer surface.

16. The ball valve of claim 15 wherein the second sealing lips contact the seal member of the valve assembly when the ball member is in the open position.

17. The ball member of claim 11 wherein the relieved areas are formed by machining portions of the spherical outer surface of the ball member.
